(19) United States
(12) Patent Application Publication
(10) Pub. No.: US 2006/0213156 A1
(43) Pub. Date: Sep. 28, 2006

(54) Animal cover having a temperature altering device

(76) Inventor: Ali Nilfuroshan, Cardiff, CA (US)

Correspondence Address: CATALYST LAW GROUP, APC, 9710 SCRANTON ROAD, SUITE S-170, SAN DIEGO, CA, 92121, US

(21) Appl. No.: 10/559,860

(22) PCT Filed: Sep. 27, 2004
(86) PCT No.: PCT/US04/31540

§ 371 Date: Dec. 6, 2005

Related U.S. Application Data
(63) Continuation of application No. 10/807,695, filed on Mar. 24, 2004.

(51) Int. Cl. B68C 5/00

(52) U.S. Cl. 54/79.1

(57) ABSTRACT

A device useful for delivering a temperature altering regimen to a specific and defined location on an animal's body, and thus altering the temperature of an animal's body, or defined area thereof. It is desirable to alter the temperature of an animal's body for a variety of reasons, including: maintaining a desirable basal body temperature in an extreme climate; maintaining basal body temperature to treat an illness affecting said temperature; providing a temperature greater or lesser than basal temperature to muscle groups and/or joints to help with swelling and aching following a strenuous workout; providing a temperature greater or lesser than basal temperature to joints to assist with pain associated with swelling due to arthritis; and to lower the temperature of a body following a strenuous workout.

### RELATED APPLICATION

Benefit of priority under 35 U.S.C. 119(e) is claimed herein to U.S. patent application Ser. No. 10/807,695, filed Mar. 24, 2004. The disclosure of the above referenced application is incorporated by reference in its entirety herein.

### FIELD OF THE INVENTION

This invention relates generally to the field of animal care, and particularly to delivering a temperature altering regimen to a specific and defined location on an animal's body.

### BACKGROUND

Covers, blankets, clothing and other articles adapted for wearing by an animal have long been used. Common examples include, clothing for dogs, fly protectors (used to prevent or lessen damage to cattle and other farm animals caused by ectoparasites, such as flies and mosquitoes) and horse blankets. Conventional horse blankets are provided to protect a horse from mud, dirt, and moisture, and to provide a degree of thermal insulation. These conventional horse blankets typically conform to the shape of a horse's upper body to provide adequate protection from the elements.

The horse blankets of the prior art provides a general protection from the elements; however, the prior art is deficient in delivering a targeted extreme temperature to a specifically focused area of the horse's body. Similarly, other animal covers and clothing merely provide a general barrier between the animal and the elements. Furthermore, the animal covers of the prior art are not useful for delivering an extreme temperature regimen to the animal's body, or to a defined area thereof. Thus, there is a need in the art for an animal cover that delivers targeted and extreme temperature to a specifically selected area of an animal's body, or to the entire body.

### SUMMARY OF THE INVENTION

One embodiment of the present invention relates to a device useful for delivering a temperature altering regimen to a specific and defined location on an animal's body. The invention is useful for altering the temperature of an animal's body, or of a specific area thereof. It is desirable to alter the temperature of an animal's body for a variety of reasons, including: maintaining a desirable basal body temperature in an extreme climate; maintaining basal body temperature to treat an illness affecting said temperature; providing a temperature greater or lesser than basal temperature to muscle groups and/or joints to help with swelling and aching following a strenuous workout; providing a temperature greater or lesser than basal temperature to joints to assist with pain associated with swelling due to arthritis; and to lower the temperature of a body following a strenuous workout. Thus, the current invention is useful in a variety of fields, including, but not limited to farming, veterinary, competition animals and home use.

In one particular aspect of the present invention, a horse blanket is provided and is used to deliver a temperature altering regimen to a competition horse. The invention comprises strategically located cavities further comprising a temperature altering device. The horse blanket, therefore, places the temperature altering device in a specific and defined location on the horse's body wherein a temperature altering regimen is delivered.

In one embodiment of the present invention, the horse blanket is provided having a plurality of cavities fixedly attached to said horse blanket In this embodiment, the horse blanket is constructed to comprise said cavities in strategic locations within the horse blanket, such that when the horse blanket is placed on an animal, the strategically located cavities come into contact with preselected locations on the horse. Typically, these preselected locations include, but are not limited to, muscle groups, joints, ligaments and tendons.

In a further embodiment of the present invention, the horse blanket is provided having at least one cavity releasably attached to said horse blanket. In this embodiment, the blanket is constructed to releasably accept at least one cavity. The blanket is placed on the horse and then a cavity containing a temperature altering device is attached to the blanket such that the cavity can deliver a temperature altering regimen to a desired location of the horse's body, including, but not limited to muscle groups, joints, ligaments and tendons. The cavity is later removed from the blanket and can be reattached in the same or in another location on the horse blanket

In one embodiment of the method, the invention is brought to a desired temperature and is utilized to deliver a temperature altering regimen to the body of an animal. Specifically, a temperature altering device is either permanently or removably enclosed in a cavity. The temperature altering device is, therefore, strategically located within said blanket such that the temperature altering device can deliver a targeted temperature altering regimen to a desired location of the horse's body, including, but not limited to muscle groups, joints, ligaments and tendons.

### BRIEF DESCRIPTION OF THE DRAWINGS

FIG. 1A shows the horse blanket embodiment of the current invention; wherein the horse blanket is laid open.

FIGS. 1B-D illustrate alternative configurations for placing the cavity on a horse blanket. The cavity further comprises a temperature altering device, thus their placement will define the region of the blanket that will deliver a temperature altering regimen.

FIG. 1E shows the horse blanket embodiment of the current invention, with cavities placed in specifically selected spots on the horse blanket and with an optional neck piece connected to the said blanket, wherein the horse blanket is shown covering the body of a horse.

FIG. 2A is a cross sectional view of a cavity embedded into a horse blanket.

FIG. 2B is a view of one embodiment for placement of an adjustable cavity in a horse blanket, specifically in this illustration on the flap of the horse blanket body.

FIG. 2C is a view of one alternative embodiment for placement of an adjustable cavity in a horse blanket, specifically in this illustration on the flap of the horse blanket body.

FIG. 3 is a cross sectional view of a cavity having a sealable pocket mouth for removably placing a temperature altering device.

FIG. 4a illustrates an alternative embodiment of the invention wherein the interior side of the animal cover comprises a material for the releasable attachment of cavities to the animal cover. Also seen in FIG. 4a is an alternative embodiment of flap 12 wherein the flap is releasably connected near the buttock and near the hip areas of the animal.

FIG. 4b illustrates an alternative embodiment of the invention wherein the exterior side of the animal cover comprises a material for the releasable attachment of cavities to the animal cover.

FIG. 5a illustrates a releasable cavity of the current invention wherein the cavity is a pocket comprising releasable material, temperature reflective material and temperature permeable material, and further comprising a pocket for holding a temperature altering device.

FIG. 5b illustrates a releasable cavity of the current invention wherein the cavity is a patch comprising releasable material and comprising either a temperature reflective material or temperature permeable material, wherein the patch can envelop a temperature altering device when used in conjunction with an animal cover having the complementary releasable material.

FIG. 6 is an illustration of flap 12 in an alternative embodiment wherein the entire flap is separable from the remainder of the animal cover body.

### DETAILED DESCRIPTION OF THE INVENTION

The current invention is a cover used to alter the temperature of a user. Preferably, the user referred to herein is an animal, more preferably, the user is a competition animal and most preferably, the user is a competition horse. For the remainder of this description of the current invention, a horse blanket will be described; however, those of ordinary skill in the art will readily adapt the current invention to a variety of covers for a variety of animals. These additional uses of the current invention, including alternative embodiments involving different types of covers, different temperature altering devices or different animals, are well within the scope of the current invention.

It is desirable to alter the temperature of an animal for a variety of reasons. Veterinarians typically use ice baths to lower the temperature of an animal suffering from a fever and will use a hot or cold press to deliver a temperature to a specific location on an animal's body. Similarly, farmers and other animal owners, particularly those in more extreme climates, desire to alter the body temperature of their animals to prevent or ameliorate hypothermia, hyperthermia, and other adverse conditions associated with exposure to extreme climates. Thus, animal blankets are frequently used on animals in extremely cold climates to keep these animals warm.

Competition animals exert maximum effort during a performance or practice, and as a result, will often develop sore muscles, inflamed joints, strained ligaments and tendons, increased body temperature and a variety of other undesirable effects. Such competition animals include, but are not limited to greyhound race dogs, thoroughbred race horses, sport horses (e.g., jumping, driving, dressage, vaulting and endurance) and agility dogs. It is desirable to deliver a specific and targeted temperature altering treatment to one or more of the sore muscles, inflamed joints, strained ligaments and tendons, increased body temperature and variety of other undesirable effects. In addition to targeting a specific area with a temperature altering regimen, it may also be desirable to deliver a first specific temperature to a first specific area and a second specific temperature to a second specific area. These and other objectives are achieved by the current invention.

The current invention is directed towards a new device and method for delivering a temperature altering regimen to an animal. In the preferred embodiment, the animal is a competitions horse. The device in this embodiment is a cover, similar to a horse blanket that covers the body of the horse and delivers a temperature altering regimen directly to a specific location on the horse's body. The device of the current invention is adjustable, allowing the temperature altering regions to precisely fit a variety of body areas of various differently shaped and sized horses. The device and method is further described below with reference to the attached drawings.

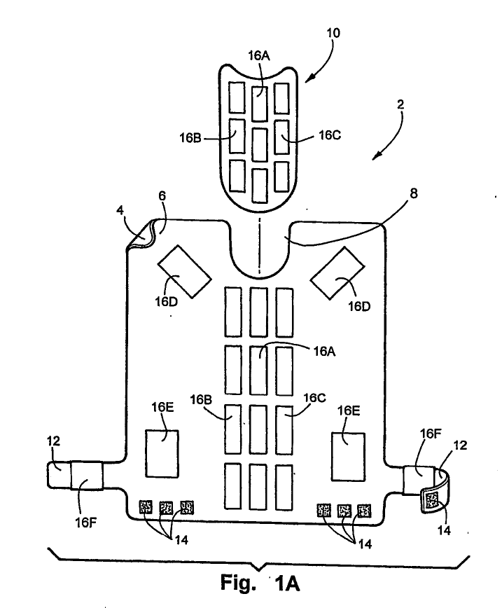

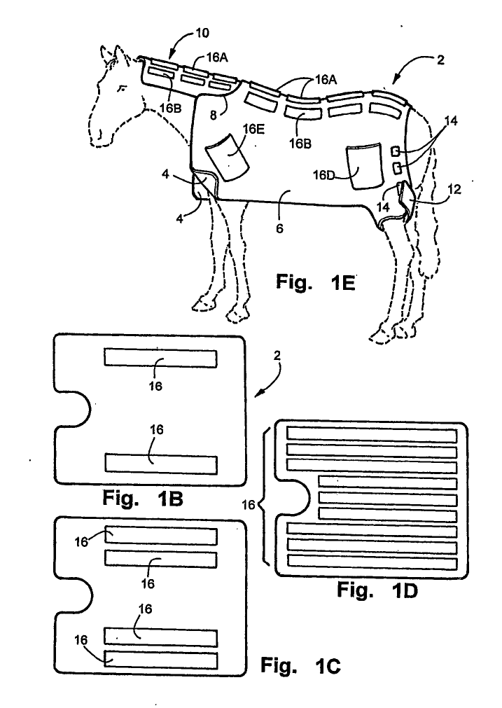

FIG. 1A is a horse blanket 2, having an interior side 4 and an exterior side 6. The interior side 4 refers to the side of the blanket that is closest to the horse's body. In the preferred embodiment, the material of interior side 4 of horse blanket 2 is constructed from a material that will wick moisture away from the body of the horse, thereby preventing rash and other problems associated with having moisture trapped against the animal's body. In the preferred embodiment, the material of exterior side 6 of horse blanket 2 is constructed from a material that will reflect temperature, thereby directing a temperature altering regimen towards the body of the animal for a maximally efficient delivery of said temperature altering regimen.

In an alternative embodiment, the material of horse blanket 2 is cotton or a cotton-polyester blend on one or both of the interior side 4 and the exterior side 6. At times it may be desirable for the horse blanket 2 to possess certain specific qualities or a combination thereof, including but not limited to a variable degree of flexibility, water impermeability, tensile strength, optical reflectivity, conductivity and elasticity. In a further alternative embodiment, the material comprising one or both of interior side 4 and exterior side 6 is a specialty material selected from the group consisting of polychloroprene, polyethylene, polyvinylidene chloride, polyacrylonitrile, polystyrene and polyamide.

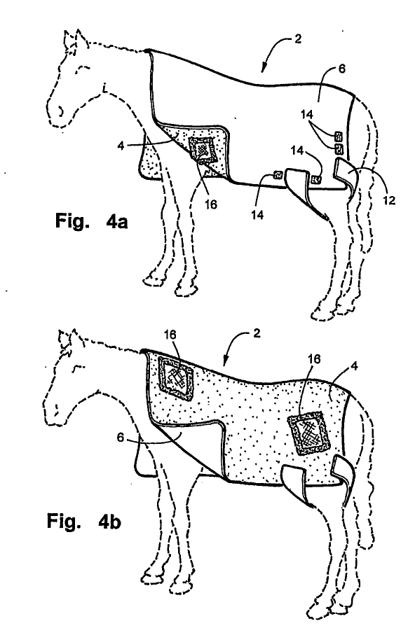

In another embodiment, the material of horse blanket 2 is comprises a loop material, such that various objects comprising a hook component are releasably attachable to various locations on the horse blanket 2. In one example configuration of this alternative embodiment, the material of interior side 4 of blanket 2 is made of loop material and the exterior side 6 of blanket 2 is made of a temperature reflective material. (FIG. 4a.) It is well known that the loop material of a hook and loop is generally the less abrasive of the materials and therefore will not irritate the horse's skin. As will be described below in further detail, the temperature altering devices of the current invention are enclosed in a cavity comprising a hook material and, therefore, are releasably attached to a variety of locations on interior side 4 of blanket 2. In FIG. 4a, the releasably attached cavity comprising a temperature altering device is generally labeled 16.

In another example configuration of this alternative embodiment, the material of exterior side 6 of blanket 2 is made of loop material. (FIG. 4b.) As will be described below in further detail, the temperature altering devices of the current invention are enclosed in a cavity comprising a hook material and, therefore, are releasably attached to a variety of locations on exterior side 6 of blanket 2. Again, the releasably attached cavity comprising a temperature altering device is generally labeled 16. In this example configuration, blanket 2 is made of a material that is permeable to a temperature altering regimen, and that can, preferably, wick moisture away form the horse's body. In a further aspect of this example configuration, the cavity comprising the temperature altering device comprises a temperature reflective cover on the outermost surface, thereby directing the temperature altering regimen through the blanket 2 and towards the horse's body.

The animal cover, which is a horse blanket 2 in the current description, can thusly, comprise a variety of materials, including, but not limited to, hook material, loop material, temperature permeable material, temperature reflective material, moisture wicking material and combinations thereof.

The front end of the horse blanket comprises a cut away portion 8 designed to fit around the horse's neck, resting just above the withers. Alternatively seen as a detached section, the horse blanket 2 comprises a protrusion 10 that covers a majority of the horse's neck, stopping just short of the horse's head. The rear sides of the horse blanket comprises flaps 12, which are fitted around the hips of the horse and releasably attached to connectors 14 at the rear of the horse blanket. Connectors 14 can be a variety of well known connectors, including, but not limited to, hook and loop, snaps, ring and clip, and buckle. Furthermore, connectors 14 can be a plurality of connectors 14 thereby allowing for an adjustable attachment of the horse blanket 2 to a variety of sized horses. The horse blanket is attached to the horse's body using fastening systems well known in the art.

It is to be understood, that the preferred embodiment wherein a horse blanket comprises the invention is by way of example only. Furthermore, horse blankets are well known in the art and the description of a horse having a cut away 8 exposing the horse's neck, or a protrusion 10 covering the horse's neck are mere descriptions of a horse blanket. Those of ordinary skill in the art will readily adapt the current invention to fit a variety of covers beyond blankets, and the covers comprising the current invention are useful on more animals that just horses. These variations are within the scope of the current invention.

Also shown in FIG. 1A horse blanket 2 comprises a plurality of cavities 16. The cavities 16 enclose the temperature altering device (not shown) and are placed at a determined position within the horse blanket 2. The cavities 16 are either permanently fixed to horse blanket 2 or are releasably attached to horse blanket 2. A horse blanket 2 can comprise all fixed cavities 16, all releasably attached cavities 16 or a combination thereof.

In FIG. 1a cavities 16a-c are strategically located within blanket 2 to contact the horse's spine 16a and spinal muscles 16b-c. Cavities 16d are strategically located within blanket 2 to contact the horse's shoulder muscles. Cavities 16e are strategically located within blanket 2 to contact the horse's hip muscles. Cavities 16f are strategically located within blanket 2 to contact the horse's stifle joint. In an alternative embodiment wherein the horse blanket further comprises a protrusion 10 covering the horse's neck, cavities 16a-c may also extend through the protrusion 10 making contact with the horse's c-spine and associated muscles. FIG. 1E illustrates the invention horse blanket 2 on a horse and having cavities 16 strategically located along the spine, spine muscles, shoulder and hips. FIG. 1B is an example only, and does not limit the current invention to a horse blanket or to having cavities in the illustrated locations.

Cavities 16 can be located in any portions of horse blanket 2 that is desired. For example, in FIG. 1B, the cavities are shown strategically located within the horse blanket 2 to contact the horse's thoracic cavity. If the horse blanket 2 is designed such that it is capable of attaching around the underside of a horse, then the cavities 16 can be strategically located to contact the horse's girth and abdomen, as is shown in FIG. 1C. In a further embodiment of the current invention, the cavities 16 are located throughout the entire horse blanket (FIG. 1D). As is described herein, cavities 16 can be either fixedly or releasably attached to horse blanket 2. These and other embodiments for locating these cavities in an animal cover are well within the scope of this current invention. In the preferred embodiment a hook and loop material is used as the releasably attachment mechanism. However, other releasable attachment mechanisms are readily employable with the current invention described herein, including, but not limited to, snaps, buttons, zippers, hook and loop and combinations thereof, and these alternate mechanisms are well within the spirit of the current invention.

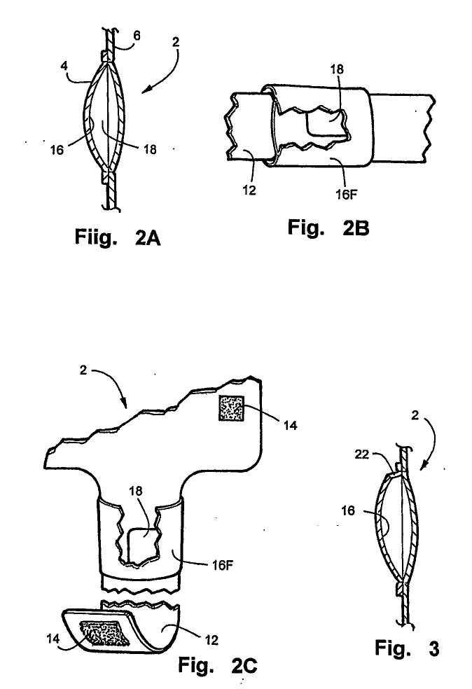

Cavities 16 are designed to hold the temperature altering device of the current invention via enclosing said temperature altering device within said cavities 16. In FIG. 2A, a cavity of the current invention is illustrated in cross sectional view. In a preferred embodiment, horse blanket 2, comprises interior side 4; exterior side 6 and cavity 16. Preferably, interior side 4 of horse blanket 2 is made of a material that wicks moisture away from the horse's body. The material of the horse blanket 2 forming cavity 16, however, preferably reflects the temperature from the temperature altering device 18 towards the body of the horse, thereby delivering an efficient temperature altering regimen to that location of the body. In this aspect, cavity 16 is surrounded by a temperature reflective material on the exterior 6 side of the horse blanket 2, and a temperature permeable material on the interior 4 side of horse blanket 2.

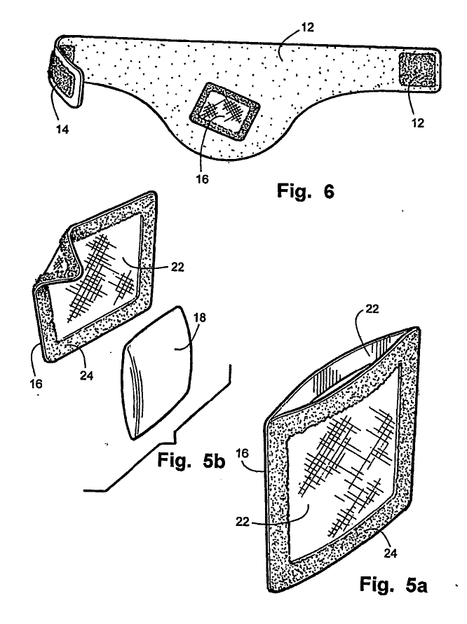

In another embodiment of the current invention wherein the horse blanket 2 comprises a loop material forming the interior side 4 or the exterior side 6, the cavities 16 are constructed separately form the horse blanket 2 and made to releasably attach with horse blanket 2. For example, wherein the interior side 4 of horse blanket 2 is a loop material, a cavity 16 of this embodiment is illustrated in FIG. 5a and comprises a first surface 22 surrounded by a hook material boarder 24. In this embodiment, the first surface is preferably a temperature reflective material and the second surface 26 (not shown), which is opposite said first surface 22 and hook material boarder 24, is preferably a temperature permeable material. Conversely, wherein the exterior side 6 of horse blanket 2 is a loop material, the first surface 22 is temperature permeable and the second surface 26 is temperature reflective. The temperature reflective surface can be slightly larger in area that the temperature permeable area, thereby preventing temperature escape from the edges of temperature permeable area.

Alternatively, and as shown in FIG. 5b, cavities 16 are designed as a patch that forms a cavity with either interior side 4 or exterior side 6 of horse blanket 2, depending on which side comprises the complementary hook or loop material. For example; when the interior side 4 of horse blanket 2 comprises a loop material, then a cavity 16 comprises a first surface 22 that is temperature permeable and comprises a hook material boarder 24. The total area of first surface 22 and hook material 24 must be sufficient to envelop a temperature altering device 18 (described in detail below) when connected to the loop material of interior side 4. In this example, exterior side 6 will preferably comprise a temperature reflective material.

In an example wherein the exterior side 6 of blanket 2 comprises a loop material, then cavity 16 is formed as in the example directly above; however, in this example, the first surface 22 is temperature reflective and the material comprising horse blanket 2 is temperature permeable. Numerous other methods for constructing the current invention having a releasably attached cavity 16 are well within the spirit of the current invention.

As is illustrated in FIG. 1a, horse blanket 2 can comprise flap 12 which is fitted around the hips of the horse and connect to the rear of horse blanket 2 using connectors 14. (See also FIG. 1e showing the flap 12 in use.) Furthermore, cavity 16f can be permanently or releasably located on the flap 12 of horse blanket 2 and deliver a temperature altering regimen to the stifle joint, inner thigh, groin and/or other anatomical parts of the horse that are positioned in that region.

For example, flap 12 will generally extend from horse blanket 2 near the front of the horse's thigh/point of hip region. Flap 12 can be placed behind the horse's thigh and releasably connect to the horse blanket near the rear of thigh/buttock region of the horse. Preferably, the releasable connection 14 is a spring clamp and loop assembly and more preferably a hook and loop connection; however, a variety of other connector mechanisms are well known in the art and can be used in this embodiment. The connector 14 is also adjustable, allowing for a conforming proper fit for flap 12 with variously sized and shaped horses. As used with the current invention, flap 12 comprises a cavity 16f for delivering a temperature altering regimen to a horse. (See FIGS. 1a and 1e.)

In one preferred embodiment, cavity 16f is adjustably attached along flap 12 for proper positioning of the temperature altering device 18. For example, as is shown in FIG. 2B, the cavity 16f is formed as a separate, unit that is slidable along the longitude of flap 12, In this example, the flap 12 is positioned as described above. Cavity 16f is circular forming a lumen through which flap 12 traverses. The lumen formed by cavity 16f is just slightly larger than the cross area of flap 12, which is encircles. Cavity 16f further comprises a temperature altering device that, when flap 12 is positioned behind the horse's thigh, is positioned to deliver a temperature altering regimen to a specific area of the thigh. That specific area can be very precisely targeted by traversing cavity 16f longitudinally along flap 12 and/or by rotating cavity 16f around flap 12. Once the desired area of the horse is in contact with the temperature altering device 18 within cavity 16f, flap 12 is securely fastened using connectors 14. It is preferred that the material forming cavity 16f is temperature permeable.

In an alternative embodiment, the cavity 16f is formed within flap 12 as described above for cavities 16a-e; however, in this example cavity 16f is much larger than the temperature altering device 18 (FIG. 2C) and thereby allows for the temperature altering device to move within said cavity 16f. (Temperature altering device 18 is detailed below.) In this alternative embodiment, the temperature altering device is moveable within flap 12, and is secured at a desired position using a clamping mechanism, or by tightly connecting flap 12 to the remainder of the horse blanket 2 using connectors 14.

In a still further alternative embodiment, flap 12 comprises a loop material and cavity 16f comprises a hook material. As is detailed above, the cavity 16f is then releasably attached to flap 12 using the hook and loop attachment material. Cavity 16f is then brought into position and delivers a temperature altering regimen as described above.

In a further embodiment illustrated in FIG. 6, flap 12 is a member separate from the remaining body of the horse blanket 2. In this embodiment, flap 12 comprises connectors 14 on both ends and the connectors 14 attach to their complementary connector 14 at the buttock end of the horse blanket 2 and at the thigh/point of hip region on the other end. (See FIG. 4a for attachment illustration.). In this example, the detached flap member further comprises a cavity 16 having a temperature altering device 18, as described herein, and the cavity 16 is placed in a specific location on the horse and then the connectors 14 are secured. This will place the cavity 16, and in turn the temperature altering device 18, in contact with a specific location in the horse body.

Other embodiments will be apparent to those of ordinary skill in the art and do not exceed the current invention. In addition, the positional cavity and/or temperature altering device is not limited to that on flap 12, as is apparent to those of ordinary skill in the art.

Temperature altering device 18 delivers a desired temperature to a specific area of a horse's body. The temperature altering device 18 of the current invention is strategically located to deliver a temperature altering regimen to an optimal location of an animal's body. The temperature altering device 18 is typically located in a cavity 16 of the current invention. In one embodiment, an animal cover has fixed cavities that are optimally located such that once said animal cover is placed on an animal the cavities are in the optimal location. Such an animal cover is made in a variety of sizes and shapes and the cavities are strategically located based on the animal's anatomy and size. In another embodiment, an animal cover has releasably attached cavities that can be strategically placed on said animal cover, and thereby optimally located to deliver a temperature altering regimen to an animal's body. Releasable attachment means are discussed above, are well known in the art, and are within the spirit of the current invention. Animal covers of this embodiment can come in a variety of sizes to fit a variety of animal types and sizes; however, optimal placement of said cavities is achieved by the releasable attachment of said cavities. As described herein, the animal cover is a horse blanket and the animal is a horse; however, the animal cover can be applicable to a variety of animals for a variety of purposes.

As stated above, the temperature altering device 18 delivers a desired temperature to a specific area of a horse's body. The delivered temperature can be either greater than or lesser than the horse's current basal temperature. Following a strenuous workout the horse's body will increase its temperature relative to basal temperature. In this example, the current invention comprises a cooling temperature altering device 18, which can be applied to the horse's body to help the horse cool down. Horses' muscles and joints will often require heat or cold, and this is particularly true following a strenuous workout or an injury. In these instances, the current invention comprises either a heating or a cooling temperature altering device 18.

A temperature altering device 18 is located within a cavity 16. The temperature altering device 18 can either be permanently located within cavity 16 or removably located within cavity 16. If the temperature altering device 18 is permanently located within cavity 16, then it can be sown within the fabric, or otherwise included within. If; however, the temperature altering device 18 is removably located within cavity 16, then cavity 16 can be in the form of a pocket, having a securable pocket mouth 22 (FIG. 3 and FIG. 5a). Pocket mouth 22 can either be on the interior side 4 or the exterior side 6 of horse blanket 2. In the preferred embodiment, pocket mouth 22 is located on exterior side 6 of horse blanket 2, thereby allowing for easy placement and removal of temperature altering device 18 while horse blanket 2 is on the horse's body.

Securable pocket mouth 22 can be closed using a variety of means well known in the art. It is preferable that the securing means for securable pocket mouth 22 are such that the entire length of securable pocket mouth 22 is sealed, thereby preventing a loss of temperature from temperature altering device 18. Securable pocket mouth 22 can be closed with a variety of securing means, including but not limited to: hook and loop, snap, zipper, button, tuck, or a variety of other means well know in the art.

Temperature altering device 18 is brought to a desired temperature; is strategically placed on the horse's body; and delivers a temperature altering regimen to that specific area of the horse's body. When temperature altering device 18 is permanently affixed within the horse blanket 2, then the entire horse blanket 2 must be subjected to a means for bringing temperature altering device 18 to a desired temperature. In one example for accomplishing this goal, the temperature altering device is a series of electrically connected heating elements having a plug mechanism on one end. The plug is electrically connected to a power source, which cause the temperature of the heating elements to rise. The heating elements can be brought to a desired temperature before the horse blanket 2 is placed on the horse, or the horse blanket 2 can remain plugged in while on the horse, providing a steady and constant source of heat or a variable source of heat such that the heat output and thus the temperature of the heating elements can be varied as desired. A cooling horse blanket 2 can similarly have cooling elements electrically connected and having a plug member at one end, providing a steady and constant cooling source or a variable cooling source such that the cooling intensity and thus the temperature of the cooling elements can be varied accordingly.

Alternatively, with a horse blanket 2 comprises a permanent temperature altering device 18, the temperature altering device 18 comprises a material that is capable of being adjusted to a desired temperature, and which will hold said temperature. Such materials are well know in the art, and include, but are not limited to gel, silica, water, bean bags, heat packs, cool packs, rice bags and other compositions. Some common examples of heat and cool pack include, without limitation: the Hot & Cold Flexible Gel Pack by 3M, Minneapolis, Minn.; Thermo-Pad Heat Packs by Hood Thermo-Pad, Summerlend, BC Canada, and the Hot/Cold Reusable Gel Pack by Accu-Therm, Taipei, Taiwan. It is well known in the art, that reusable gel materials are very efficient at obtaining and maintaining for some time a desired temperature or range of temperatures, and are useful for delivery of a temperature or range of temperatures to a part of the body. The temperature of these materials is generally altered using refrigeration, ovens, submersion in hot or cold water; microwaves, endothermic or exothermic chemical reactions and like methods.

With the current invention wherein said horse blanket 2 comprises a permanent temperature altering device 18, and the temperature altering device 18 further comprises a gel or other medium, the entire horse blanket 2 must be exposed to the external temperature. In this embodiment, the refrigeration, oven, microwave or endothermic or exothermic chemical reaction means are preferable. Submersion ill hot or cold water is useful when the horse blanket is made of a material that can get wet without any adverse effects to the horse blanket 2 or the horse. Preferably, the horse blanket 2 is placed in a heating or cooling environment; the heating or cooling environment activates the temperature altering device 18 to reach a desired temperature; the horse blanket 2 with activated temperature altering device is placed on the horse strategically locating the temperature altering device 18 near a specific area of the horse's body, and a temperature altering regimen will take place. Should temperature altering device return to a temperature that is no longer useful for the temperature altering regimen, then the necessary steps should be repeated to bring temperature altering device 18 to a desired temperature and, thus, continue delivery of a temperature altering regimen. Suitable materials and devices useful for delivering a temperature altering regimen will be obvious to use in conjunction with the current invention, and one of ordinary skill in the art will readily do so without exceeding the scope of the current invention.

Horse blanket 2 can comprise temperature altering device 18 removably located in cavity 16. In this embodiment, the temperature altering device 18 can be a heating or cooling element, a gel pack similar to that used in heat and cool packs, a gel, silica, water, bean bags, rice bags and other compositions for altering temperature. Similar to the above description, these temperature altering devices can be electrically connected to a power source (for the heating or cooling element) or can be placed in a temperature altering environment, brought to a desired temperature through physical or chemical means and then returned to horse blanket 2 to deliver a temperature altering regimen. If a heat pack or cool pack is used, then submersion in hot or cold water is one means for adjusting the temperature of said temperature altering device 18, because only the packs and not the whole blanket will be submerged in water. Also, in this embodiment, temperature altering device 18 can be a single use device or material. For example, cavity 16 can be filled with ice, or with an activated disposable heat or cool pack (e.g., those containing sodium chloride and water for heat, or those containing ammonium nitrate and water for cold). If a heat pack or cool pack is used, another means for adjusting the temperature of said temperature altering device 18 is filling the heat pack or cool pack with gel or other medium, wherein such gel or medium can be activated to undergo an exothermic or endothermic chemical reaction, resulting in heat release or absorption respectively. Such gel or other medium can include, without limitation: sodium acetate, sodium chloride and water, ammonium nitrate and water, or any other suitable composition. Suitable materials and devices useful for delivering a temperature altering regimen will be obvious to use in conjunction with the current invention, and one of ordinary skill in the art will readily do so without exceeding the scope of the current invention.

If the temperature altering device 18 is removably located in cavity 16, then said temperature altering device 18 is removed from the cavity through sealable pocket mouth 22; is brought to a desired temperature; is returned to cavity 16; sealable pocket mouth 22 is sealed; and a temperature altering regimen is delivered to strategic locations on the horse's body. Depending on whether sealable pocket mouth 22 is located on the interior side 4 or exterior side 6 of horse blanket 2, will determine ease of removing and replacing temperature altering device 18 from cavity 16 when the horse blanket 2 is on the horse. When sealable pocket mouth 22 is on the exterior side 6 of horse blanket 2, then the temperature altering device can easily be removed and replaced from cavity 16 when horse blanket 2 is on the horse. More difficult, is removing and replacing temperature altering device when sealable pocket mouth 22 is located on the interior side 4 of horse blanket 2 when the horse blanket 2 is on the horse. Cavities 16a-c located at or near the spine and spinal muscles of the horse may be impossible to access when the horse blanket 2 is on the horse. Thus, it is preferable that sealable pocket mouth 22 is located on the exterior side 6 of horse blanket 2. Alternatively, if sealable pocket mouth 22 is on the interior side 4 of horse blanket 2, it is preferable that the activated temperature altering device is placed within cavity 16 and then horse blanket 2 is placed on the horse's body.

Various modifications and alterations of the invention will become apparent to those skilled in the art without departing from the spirit and scope of the invention, which is defined by the accompanying claims. For example, it should be noted that steps recited in any method claims below do not necessarily need to be performed in the order that they are recited. Those of ordinary skill in the art will recognize variations in performing the steps from the order in which they are recited. For example, in certain embodiments, steps may be performed simultaneously. The accompanying claims should be constructed with these principles in mind.

We claim:

1. An animal cover adapted to conform to the shape of an animal's body to deliver a temperature to a specific targeted area of the body, the animal cover comprising:
a. a body of the animal cover having an interior and exterior side;
b. a plurality of cavities strategically located within the body of the animal cover to deliver a temperature altering regimen to a targeted area of the animal's body; and
c. a temperature altering device.

2. The animal cover of claim 1 wherein the plurality of cavities are strategically located within the body of said animal cover to deliver a temperature altering regimen to an area of the animal's anatomy selected from the group consisting of: neck, withers, spine, scapula, back, loin, croup, thigh, buttock, stifle, abdomen, girth, elbow, forearm, arm, chest, shoulder and neck.

3. The animal cover of claim 2 wherein the plurality of cavities are strategically located within the body of said animal cover to deliver a temperature altering regimen to the animal's muscle groups selected from the group consisting of: spine, shoulder, neck, thigh and hip.

4. The animal cover of claim 2 wherein the plurality of cavities are strategically located within the body of said animal cover to deliver a temperature altering regimen to the animal's joints selected from the group consisting of: stifle, hip, shoulder and elbow.

5. The animal cover of claim 1 wherein the temperature altering device is located within the plurality of cavities.

6. The animal cover of claim 5 wherein the temperature altering device is permanently located in the plurality of cavities.

7. The animal cover of claim 5 wherein the temperature altering device is removably located in the plurality of cavities.

8. The animal cover of claim 7 wherein the plurality of cavities form a sealable pocket for holding the temperature altering device, said sealable pocket further comprising a seal selected from the group consisting of: hook and loop, zipper, buttons, naps and combinations thereof.

9. The animal cover of claim 1 wherein the temperature altering device is brought to a desired temperature by placing the entire animal cover in a refrigerated or heated environment until said temperature altering device reaches a desired temperature and can be used to deliver a temperature altering regimen to an animal.

10. The animal cover of claim 1 wherein the temperature altering device is removed from said animal cover and is brought to a desired temperature by placing said temperature altering devices in a refrigerated or heated environment until said temperature altering device reaches a desired temperature and can be returned to said animal blanket and used to deliver a temperature altering regimen to an animal.

11. The animal cover of claim 10 wherein the temperature altering device is within the plurality of cavities which are releasably attached to said animal cover.

12. The animal cover of claim 1 wherein the body of said animal cover is made of a material selected from the group consisting of hook, loop, temperature reflective material, temperature permeable material, material that wicks moisture, and combinations thereof.

13. The animal cover of claim 1 wherein the body of the animal cover comprises a material that will wick moisture away from the body of the animal.

14. The animal cover of claim 13 wherein the interior side of said animal cover comprises a material that will wick moisture away from the body of the animal.

15. The animal cover of claim 1 wherein the body of said animal cover comprises a material that reflects temperature.

16. The animal cover of claim 15 wherein the exterior side of said animal cover comprises a temperature reflective material

17. The animal cover of claim 1 wherein the body of said animal cover comprises a material that is permeable to temperature.

18. The animal cover of claim 17 wherein the interior side of said animal cover comprises a material that is permeable to temperature.

19. The animal cover of claim 1 wherein the body of said animal cover comprises a material to facilitate the releasable attachment of the cavities to said body, said material being selected from the group consisting of hook, loop, snaps, buttons, zippers and combinations thereof.

20. The animal cover of claim 19 wherein the interior side of said animal cover comprises a loop material to facilitate the releasable attachment of the cavity.

21. The animal cover of claim 20 wherein the cavity comprises a hook material.

22. The animal cover of claim 19 wherein the exterior side of said animal cover comprises a loop material to facilitate the releasable attachment of the cavity.

23. The animal cover of claim 22 wherein the cavity comprises a hook material.

24. The animal cover of claim 1 wherein the plurality of cavities further comprise a material on the exterior side of the body of said animal cover that will reflect the temperature emitted from the temperature altering device towards the body of the animal for maximum efficiency of temperature transfer.

25. The animal cover of claim 1 wherein the plurality of cavities further comprise a material on the interior side of the body of said animal cover that is permeable to temperature emitted from the temperature altering device towards the body of the animal for maximum efficiency of temperature transfer.

26. The animal cover of claim 1 wherein the plurality of cavities are adjustable about the body of the animal cover for optimal placement on a variety of differently sized animals.

27. The animal cover of claim 26 wherein the plurality of cavities are adjustable about the body of the animal cover using a releasable attachment mechanism selected from the group consisting of hook and loop, snaps, fasteners, sliding cavities and oversized cavities compared to enclosed temperature altering device.

28. The animal cover of claim 27 wherein the releasable attachment mechanism is hook and loop.

29. The animal cover of claim 26 wherein the cavity for delivering a temperature altering regimen to the stifle is located on a flap of the body of said animal cover, said flap wraps from the outer thigh around to the inner thigh and is adjustably attached to the animal cover.

30. The animal cover of claim 29 wherein the cavity for delivering a temperature altering regimen to the stifle is adjustable about the flap of the body of the animal cover, allowing for optimal positions of the temperature altering device between the stifle joint and the abdomen/groin area of the animal.

31. The animal cover of claim 1 wherein the animal is selected from the group consisting of horse, dog; llama, sheep and cat.

32. The animal cover of claim 1 wherein said animal cover is a horse blanket and the animal is a horse.

33. A method for delivering a temperature altering regimen comprising the steps of:
a. altering the temperature of a temperature altering device portion of an animal cover wherein said animal cover is designed or fitted to hold said temperature altering device in a cavity and thereby deliver a temperature altering regimen to specific areas of an animal's body;
b. placing the animal cover on the body of an animal;
c. optimally locating said temperature altering device is near a specific area of said animal's body; and
c. allowing a temperature altering regimen to run its course.

34. The method of claim 33 wherein the step of altering the temperature of an animal cover comprises placing the entire animal cover into a refrigeration or heating environment and allowing the temperature altering device to reach a desired temperature.

35. The method of claim 33 wherein the step of altering the temperature of an animal cover comprises separating the temperature altering device from the body of the animal cover, placing said temperature altering device into a refrigeration or heating environment, allowing said temperature altering device to reach a desired temperature, and replacing said temperature altering device into said animal cover.

36. The method of claim 35 wherein the temperature altering device remains within a cavity, said cavity being releasably attached to said body of the animal cover, thus the cavity and the temperature altering device are separated from body of the animal cover, placed into a refrigeration or heating environment, allowed to reach a desired temperature, and replaced onto said animal cover.

37. The method of claim 35 wherein the temperature altering device is removed from the cavity, thus only the temperature altering device is separated from body of the animal cover, placed into a refrigeration or heating environment, allowed to reach a desired temperature, and is then replaced into a cavity of said animal cover.

38. The method of claim 33 wherein the step of placing the animal cover on the body of an animal comprises adjusting and properly aligning said animal cover to allow for the optimally locating the temperature altering device at an area of the animal's body to receive a temperature altering regimen.

39. The method of claim 38 wherein the step of placing the animal cover on the animal further comprises wrapping the animal cover around the outer thigh and the inner thigh of the animal to optimally locate a temperature altering device between the stifle and the groin of the animal's body.

40. The method of claim 33 wherein the step of optimally locating the temperature altering device at an area of the animal's body further comprises strategically placing releasable cavities having temperature altering devices on the body of the animal cover.

41. The method of claim 40 wherein the animal cover is on the animal and then the releasable cavities are optimally located on the body of the animal cover.

42. The method of claim 33 wherein the step of allowing the temperature altering regimen to run its course comprises letting the temperature altering device deliver temperature to the animal's body for an optimally defined period of time.

43. The method of claim 42 wherein the step of allowing the temperature altering regimen to run its course further comprises repeating the steps of altering the temperature of the animal cover and placing the animal cover on the body of an animal.

44. The method of claim 33 wherein the animal is selected from the group consisting of horse, dog; llama, sheep and cat.

45. The animal cover of claim 33 wherein said animal cover is a horse blanket and the animal is a horse.

46. An animal cover adapted to conform to the shape of an animal's body to deliver a temperature to a specific targeted area of the body, the animal cover comprising:
a. a body of the animal cover having at least an interior and exterior side; and
b. a plurality of releasably attached cavities.

47. The animal cover of claim 46 wherein the body of said animal cover comprises a material selected from the group consisting of hook, loop, temperature reflective material, temperature permeable material, material that wicks moisture, and combinations thereof.

48. The animal cover of claim 47 wherein the body of said animal cover comprises a temperature reflective material on the exterior side of said animal cover.

49. The animal cover of claim 47 wherein the body of said animal cover comprises a temperature permeable material on the interior side of said animal cover.

50. The animal cover of claim 47 wherein the body of said animal cover comprises a material that will wick moisture on the interior side of said animal cover.

51. The animal cover of claim 50 wherein moisture is wicked away from the animal's body.

52. The animal cover of claim 47 wherein the body of said animal cover comprises a loop material on the interior side of said animal cover.

53. The animal cover of claim 47 wherein the body of said animal cover comprises a hook material or a loop material on the exterior side of said animal cover.

54. The animal cover of claim 46 wherein the plurality of releasably attached cavities comprise a release mechanism selected from the group consisting of, hook, loop, snaps, buttons, zippers and combinations thereof and the animal cover comprises a complementary release mechanism.

55. The animal cover of claim 54 wherein the plurality of releasably attached cavities comprise a hook material or a loop material and the animal cover comprises the complimentary loop material or hook material, respectively.

56. The animal cover of claim 55 wherein the plurality of releasably attached cavities releasably attach to the interior side of the animal cover.

57. The animal cover of claim 55 wherein the plurality of relesably attached cavities releasably attach to the exterior side of the animal cover.

58. A cavity comprising a means for releasably attaching said cavity to an animal cover further comprising an interior side and an exterior side.

59. The cavity of claim 58 wherein said means for releasably attaching said cavity to an animal cover is a means selected from the group consisting of hook and loop, zipper, snaps, buttons and combinations thereof.

60. The cavity of claim 59 wherein said means for releasably attaching said cavity to an animal cover is a hook and loop means wherein the cavity comprises either a hook material or a loop material and the animal cover comprises the complementary loop material or hook material.
